(19) United States
(12) Patent Application Publication
(10) Pub. No.: US 2010/0088600 A1
(43) Pub. Date: Apr. 8, 2010

(54) REDIRECTION OF AN AVATAR

(76) Inventors: Rick A. Hamilton, II, Charlottesville, VA (US); James R. Kozloski, New Fairfield, CT (US); Clifford A. Pickover, Yorktown Heights, NY (US); James W. Seaman, Falls Church, VA (US)

Correspondence Address: HOFFMAN WARNICK LLC, 75 STATE ST, 14 FL, ALBANY, NY, 12207, US

(21) Appl. No.: 12/247,213

(22) Filed: Oct. 7, 2008

(51) Int. Cl. G06F 17/30; G06F 3/048

(52) U.S. Cl. 715/706; 707/E17.009

(57) ABSTRACT

The invention provides a method, system, and program product for redirecting an avatar within a virtual universe or between virtual universes. In one embodiment, the invention includes identifying a region within a virtual universe that an avatar is attempting to access, determining whether the region is available to the avatar, and in the case that the region is not available to the avatar, determining whether the avatar's attempt to access the region is based on an event scheduled in the region, and in the case that the avatar's attempt to access the region is based on an event scheduled in the region, determining whether the event has been relocated to a second region, in the case that the event has been relocated to a second region, offering to teleport the avatar to the second region, and in the case that the avatar chooses to be teleported to the second region, teleporting the avatar to the second region.

### TECHNICAL FIELD

The present invention relates generally to virtual universes and, more particularly, to the redirection of an avatar within a virtual universe or between virtual universes.

### BACKGROUND OF THE INVENTION

A virtual universe (VU) is a computer-based simulated environment intended for its residents to traverse, inhabit, and interact through the use of avatars. Many VUs are represented using three-dimensional graphics and landscapes and are populated by many thousands of users, known as residents. Often, the VU resembles the real world with respect to the environment (e.g., houses, landscapes, laws of physics, etc.), society, and economy.

As VUs become increasingly available, stable, and popular, they are now regularly being used as meeting places for individuals, teams, and businesses. Often, an individual, team, or business will schedule a time and place within the VU to perform some function, gather for a meeting, or conduct other business. A problem arises, however, when the desired region within the VU is unavailable when an avatar attempts to access it. In such a case, an individual user may be unfamiliar with alternate regions within which his or her avatar may perform similar functions. Without contingency planning for every scheduled meeting, a group of users may be unable to assemble their avatars to carry out the activities they had planned.

Accordingly, there exists a need in the art to overcome the deficiencies and limitations described hereinabove.

### SUMMARY OF THE INVENTION

The invention provides a method, system, and program product for redirecting an avatar within a virtual universe or between virtual universes.

A first aspect of the invention provides a method of redirecting an avatar, the method comprising: identifying a region within a virtual universe that an avatar is attempting to access; determining whether the region is available to the avatar; and in the case that the region is not available to the avatar: determining whether the avatar's attempt to access the region is based on an event scheduled in the region; and in the case that the avatar's attempt to access the region is based on an event scheduled in the region: determining whether the event has been relocated to a second region; in the case that the event has been relocated to a second region, offering to teleport the avatar to the second region; and in the case that the avatar chooses to be teleported to the second region, teleporting the avatar to the second region.

A second aspect of the invention provides a system for redirecting an avatar, the system comprising: a system for identifying a region within a virtual universe that an avatar is attempting to access; a system for determining whether the region is available to the avatar; a system for determining whether the avatar's attempt to access the region is based on an event scheduled in the region; a system for determining whether the event has been relocated to a second region; a system for offering to teleport the avatar to the second region; and a system for teleporting the avatar to the second region.

A third aspect of the invention provides a program product stored on a computer-readable medium, which when executed, redirects an avatar, the program product comprising: program code for identifying a region within a virtual universe that an avatar is attempting to access; program code for determining whether the region is available to the avatar; program code for determining whether the avatar's attempt to access the region is based on an event scheduled in the region; program code for determining whether the event has been relocated to a second region; program code for offering to teleport the avatar to the second region; and program code for teleporting the avatar to the second region.

A fourth aspect of the invention provides a method for deploying an application for redirecting an avatar, comprising: providing a computer infrastructure being operable to: identify a region within a virtual universe that an avatar is attempting to access; determine whether the region is available to the avatar; determine whether the avatar's attempt to access the region is based on an event scheduled in the region; determine whether the event has been relocated to a second region; offer to teleport the avatar to the second region; and teleport the avatar to the second region.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-3 show the redirection of an avatar according to alternative embodiments of the invention;

FIG. 4 shows a flow diagram of an illustrative method according to the invention; and

FIG. 5 shows a block diagram of an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, “virtual universe” is meant to be interchangeable with “virtual world” and similar terms and phrases known to one skilled in the art. Virtual universes include, without limitation, Second Life®, Entropia Universe®, The Sims Online™, There, Red Light Center, EverQuest®, Ultima Online™, Lineage, and World of Warcraft®.

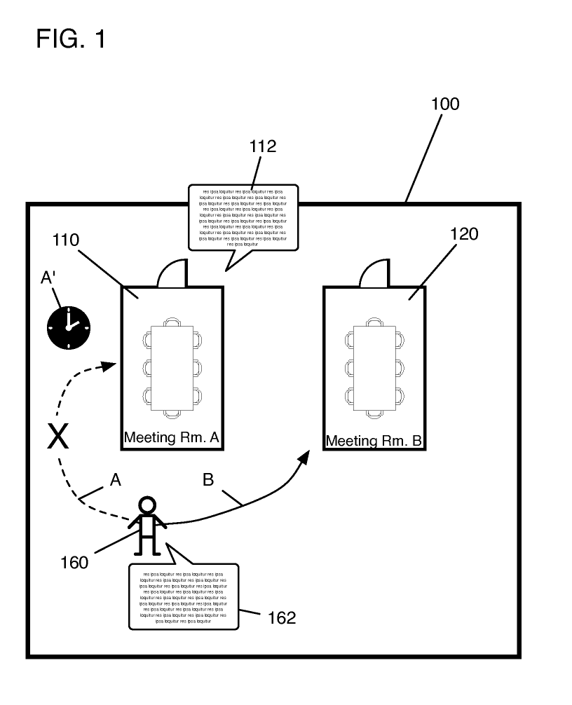

Turning now to the drawings, FIG. 1 provides a representation of a virtual universe 100 including a plurality of regions 110, 120 and an avatar 160 attempting to access A region 110 (Meeting Rm. A). At the time the avatar 160 attempts such access, however, it is determined that the region 110 is unavailable. As used herein, the term “unavailable” means that the region is completely inaccessible, running too slowly, or is otherwise unable to provide a meaningful experience to the avatar 160.

The determination that the region 110 is unavailable may include a temporal component A′, such that it is determined that the avatar 160 has repeatedly attempted to access A the region 110 and/or that the avatar 160 has attempted to access A the region 110 within a particular period of time and it has been determined at one or more of prior attempt that the region 110 was unavailable. This may preclude a determination that the region 110 is unavailable when, in fact, such unavailability is sporadic and/or of short duration.

Once it is determined that the region 110 is unavailable, region data 112 and/or avatar profile data 162 may be examined to determine whether the avatar's attempt to access the region 110 was based on an event scheduled in the region 110. That is, it is determined whether the avatar was attempting to access the region 110 for a reason more significant than mere entertainment or serendipity. For example, examining the region data 112 may reveal that a meeting of avatars is scheduled to occur at or about the time that the avatar attempted to access the region 110. Region data 112 may even reveal that the avatar 160 is scheduled to attend the meeting. Examining the avatar profile data 162 may also reveal such a scheduled meeting or may reveal, for example, that the avatar periodically visits the region 110 and performs a particular act (e.g., banking, purchases, etc.). In either case, it may be determined that the avatar's attempt to access the region 110 was based on an event scheduled in the region 110.

In the case that the avatar 160 was attempting to access the region 110 based on an event scheduled in the region, it is determined whether the event has been rescueduled to a new location. This may be discovered, for example, by examining region data 112. For example, region data 112 may indicate that the scheduled event has been rescheduled to a second region 120, in which case the avatar 160 may be offered the option of being teleported B to the second region 120.

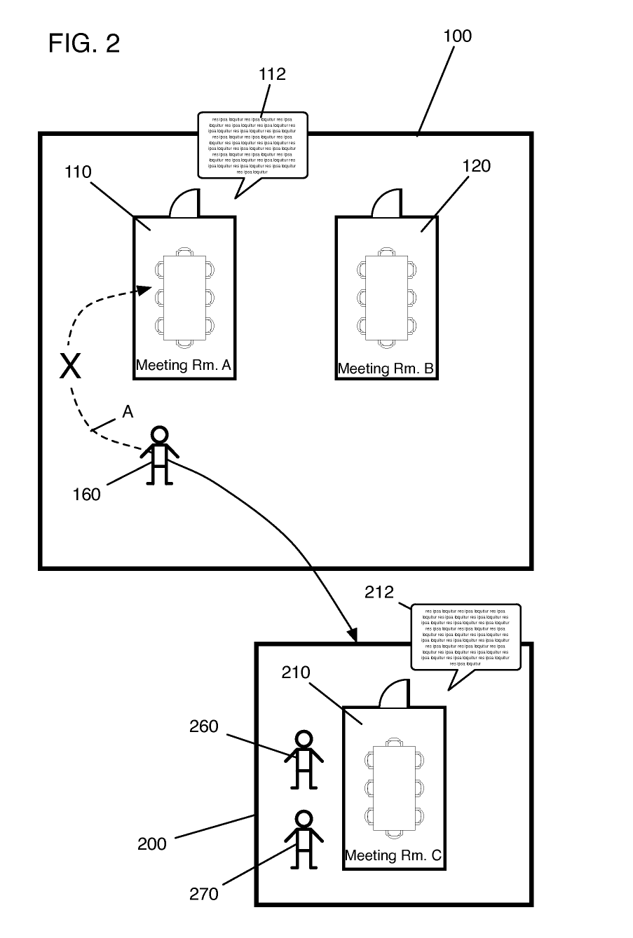

In some cases, the region to which the avatar is teleported may be in another VU. For example, as shown in FIG. 2, the avatar 160 may be teleported C to an alternate region 210 within an alternate VU 200 based on an examination of region data 112, alternate region data 212, or both. It is possible that other avatars 260, 270 may have already been teleported to the alternate region 210 if, for example, they, too, were scheduled to attend the event at region 110 and found it to be unavailable.

It is possible, of course, that a second region has not been designated for the event. In such a case, according to an embodiment of the invention, the second region may be designated and the avatar 160 and any other avatars attempting to access the unavailable region teleported to the second region. This increases the likelihood that avatars originally intending to meet for the same event in the unavailable region will be teleported to a common region. In many cases, where the event consists entirely or primarily of avatar-to-avatar interaction, the particular region chosen for the event is of little consequence and the newly-designated region may provide the same opportunity for the event to take place.

In other embodiments of the invention, a region to which avatars are teleported may be dynamically created. For example, where the region an avatar attempts to access is unavailable, a new region may be created and the avatar teleported to that region. In some embodiments, the newly-created region is based on an examination of the avatar profile data 162 and/or the region data 112, such that the newly-created region includes features, services, products, etc. desirable or useful to the avatar and/or may be found in the unavailable region 110.

In some cases, of course, an avatar will not be attempting to access the region 160 based on an event scheduled there. It may be that the avatar's attempt to access the region was for purposes of entertainment (e.g., where the region offers products or services related to entertainment) or mere serendipity (e.g., the avatar may simply be exploring regions within the VU). In such a case, it may be possible to provide the avatar with a meaningful or enjoyable experience by teleporting the avatar to a region similar to the one determined to be unavailable. For example, if the avatar had attempted to access a particular nightclub and found it to be unavailable, the avatar may be equally satisfied by accessing another nightclub offering the same activities (e.g., type of music, dance, or other entertainment).

Accordingly, in other embodiments of the invention, if a region is determined to be unavailable, the avatar may be offered to be teleported to a similar region and, if the avatar so chooses, the avatar may be teleported to the similar region. Identifying a region similar to the one that is unavailable may be accomplished in any number of ways. For example, the avatar's profile data 162 may be examined to identify similar regions that the avatar has actually visited or to identify the avatar's likes or dislikes. The region data 112 may also be examined to determine the types of entertainment, activities, or services it makes available to its visitors and then searching the same VU or another VU for regions offering the same entertainment, activities, or services.

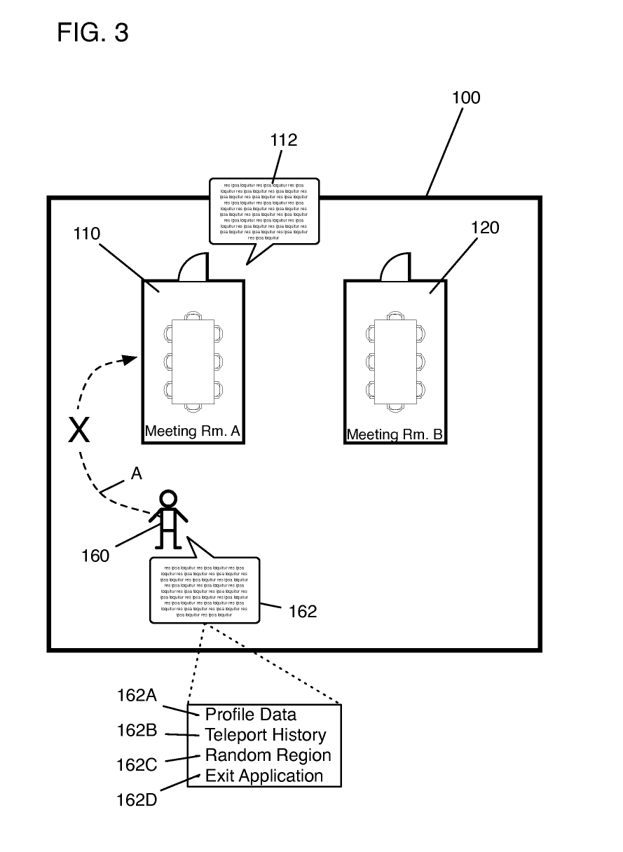

If a similar region cannot be identified or are unavailable, the avatar may still be afforded the opportunity for a meaningful or enjoyable experience by offering to teleport the avatar elsewhere. As shown in FIG. 3, the avatar profile data 162 is examined and the avatar 160 is offered to be teleported based on one or more criteria. For example, the avatar 160 may be offered to be teleported based on the avatar's profile data 162A (e.g., the avatar's likes and dislikes, age, sex, etc.), based on the avatar's teleport history 162B, to a random region 162C within the same VU or a different VU, or, if the user so chooses, may be offered the opportunity to exit the application 162D by which the user has accessed the VU.

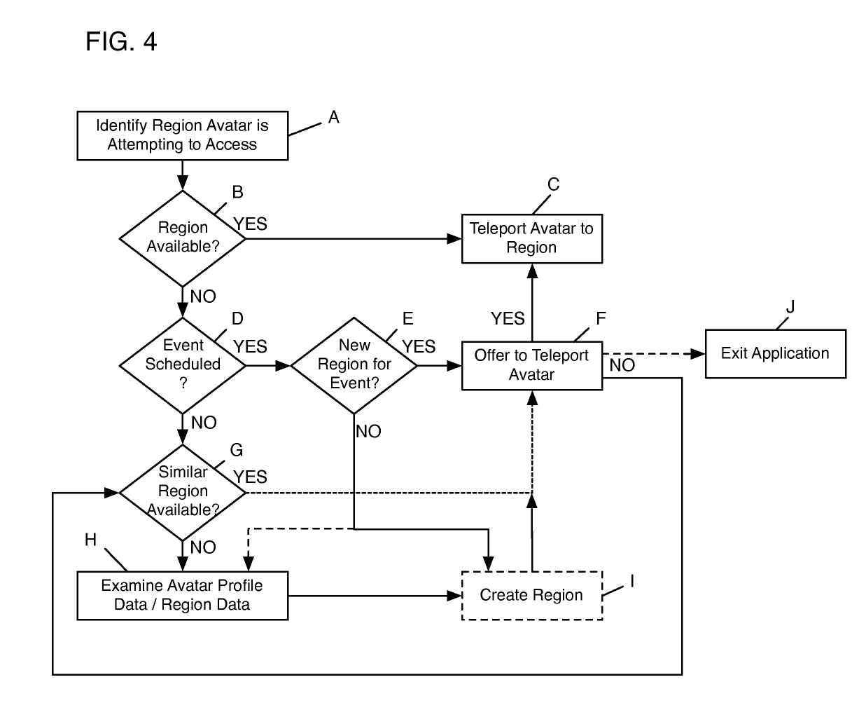

FIG. 4 shows a flow diagram of an illustrative method according to an embodiment of the invention. At A, the region an avatar is attempting to access is identified. At B, it is determined whether that region is available. If it is (i.e., YES at B), the avatar is teleported to the region at C.

If the region is not available (i.e., NO at B), it is determined at D whether an event is scheduled at the region. If an event is not scheduled at the region (i.e., NO at D), it may be determined at G whether one or more similar regions are available to which the avatar might be teleported. If so (i.e., YES at G), the avatar may be offered such teleportation at F, with further flow as described above.

If an event has been scheduled at the region (i.e., YES at D), it is then determined at E whether a new region has been established for the event. If so (i.e., YES at E), the avatar is offered to be teleported to the new region at F and, if the avatar so chooses (i.e., YES at F), the avatar is teleported to the region at C. If not (i.e., NO at F), the user may be given the option of exiting the application by which the VU was accessed. Alternatively, it may be determined at G whether similar regions are available to which the avatar might be teleported.

If a new region has not been established (i.e., NO at E) or similar regions are unavailable (i.e., NO at G), a new region may be dynamically created at I, as noted above. In some embodiments, the avatar's profile data and/or the region data of the unavailable region may be examined at H in order to create the new region at I.

It should be recognized that the method shown in FIG. 4 is merely illustrative of methods according to the invention. Many alternative flows and actions are possible and within the scope of the invention.

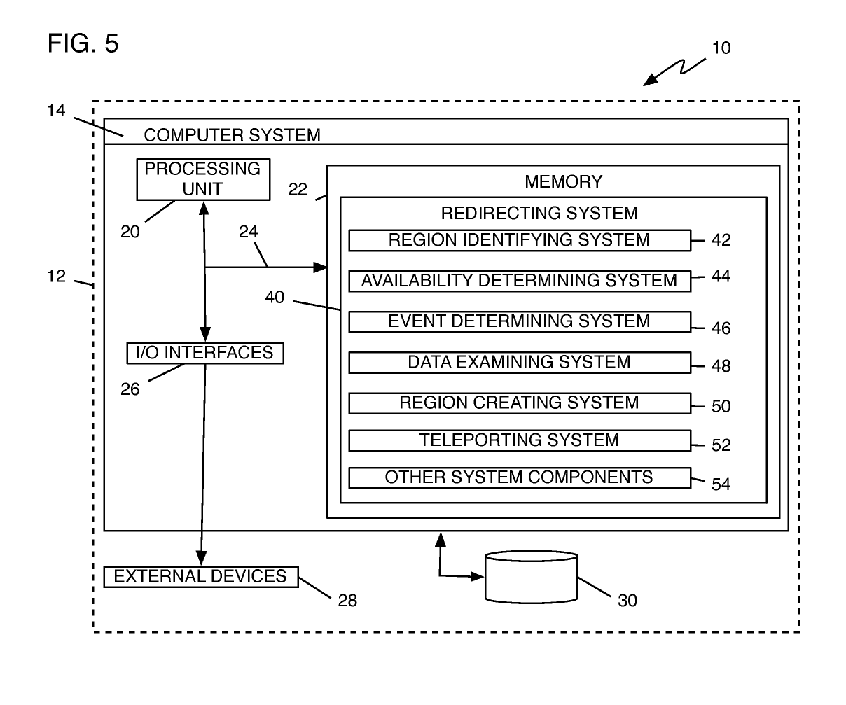

FIG. 5 shows an illustrative system 10 for redirecting an avatar. To this extent, system 10 includes a computer infrastructure 12 that can perform the various process steps described herein for redirecting an avatar. In particular, computer infrastructure 12 is shown including a computer system 14 that comprises an redirecting system 40, which enables computer system 14 to redirect an avatar by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as redirecting system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and redirecting system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the redirecting system 40 enables the computer system 14 to redirect an avatar. To this extent, the redirecting system 40 is shown including a region identifying system 42, an availability determining system 44, an event determining system 46, a data examining system 48, a region creating system 50, and a teleporting system 52. Operation of each of these systems is discussed above. The redirecting system 40 may further include other system components 54 to provide additional or improved functionality to the redirecting system 40. It is understood that some of the various systems shown in FIG. 5 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for redirecting an avatar, it is understood that the invention further provides various alternative embodiments. For example, in one embodiment, the invention provides a computer-readable medium that includes computer program code to enable a computer infrastructure to redirect an avatar. To this extent, the computer-readable medium includes program code, such as redirecting system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to redirect an avatar, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for redirecting an avatar. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of redirecting an avatar, the method comprising:
identifying a region within a virtual universe that an avatar is attempting to access;
determining whether the region is available to the avatar; and
in the case that the region is not available to the avatar:
determining whether the avatar's attempt to access the region is based on an event scheduled in the region; and
in the case that the avatar's attempt to access the region is based on an event scheduled in the region:
determining whether the event has been relocated to a second region;
in the case that the event has been relocated to a second region, offering to teleport the avatar to the second region; and
in the case that the avatar chooses to be teleported to the second region, teleporting the avatar to the second region.

2. The method of claim 1, wherein determining whether the region is available to the avatar includes determining whether the avatar has previously attempted to access the region.

3. The method of claim 1, wherein determining whether the avatar's attempt to access the region is based on an event scheduled in the region includes examining the avatar's profile data.

4. The method of claim 1, further comprising:
in the case that the event has not been relocated to a second region:
designating a region to which avatars attempting to access the unavailable region will be teleported;
offering to teleport the avatar to the designated region; and
in the case that the avatar chooses to be teleported to the designated region, teleporting the avatar to the designated region.

5. The method of claim 4, wherein the designated region is dynamically created.

6. The method of claim 1, further comprising:
in the case that the avatar's attempt to access the region is not based on an event scheduled in the region:
determining whether a similar region is available;
in the case that a similar region is available, offering to teleport the avatar to a similar region; and
in the case that the avatar chooses to be teleported to a similar region, teleporting the avatar to a similar region.

7. The method of claim 6, wherein determining whether a similar region is available includes examining the avatar's profile data.

8. The method of claim 6, further comprising:
in the case that a similar region is not available, offering the avatar at least one of the following: to be teleported based on the avatar's profile data, to be teleported based on the avatar's teleport history, to be teleported to a random region, or to exit the application providing access to the virtual universe;
in the case that the avatar chooses to be teleported based on the avatar's profile data or teleport history or chooses to be teleported to a random region, teleporting the avatar to an applicable region; and
in the case that the avatar chooses to exit the application, exiting the application.

9. The method of claim 6, wherein the similar region is a region to which at least one additional redirected avatar had been teleported.

10. A system for redirecting an avatar, the system comprising:
a system for identifying a region within a virtual universe that an avatar is attempting to access;
a system for determining whether the region is available to the avatar;
a system for determining whether the avatar's attempt to access the region is based on an event scheduled in the region;
a system for determining whether the event has been relocated to a second region;
a system for offering to teleport the avatar to the second region; and
a system for teleporting the avatar to the second region.

11. The system of claim 10, further comprising:
a system for determining whether the avatar has previously attempted to access the region.

12. The system of claim 10, further comprising:
a system for examining the avatar's profile data.

13. The system of claim 10, further comprising:
a system for designating a region to which avatars attempting to access the unavailable region will be teleported;
a system for offering to teleport the avatar to the designated region; and
a system for teleporting the avatar to the designated region.

14. The system of claim 13, further comprising:
a system for dynamically creating the designated region.

15. The system of claim 10, further comprising:
a system for determining whether a similar region is available;
a system for offering to teleport the avatar to a similar region; and
a system for teleporting the avatar to a similar region.

16. The system of claim 15, further comprising:
a system for offering the avatar at least one of the following: to be teleported based on the avatar's profile data, to be teleported based on the avatar's teleport history, to be teleported to a random region, or to exit the application providing access to the virtual universe;
a system for teleporting the avatar to an applicable region; and
a system for exiting the application.

17. A program product stored on a computer-readable medium, which when executed, redirects an avatar, the program product comprising:
program code for identifying a region within a virtual universe that an avatar is attempting to access;
program code for determining whether the region is available to the avatar;
program code for determining whether the avatar's attempt to access the region is based on an event scheduled in the region;
program code for determining whether the event has been relocated to a second region;
program code for offering to teleport the avatar to the second region; and
program code for teleporting the avatar to the second region.

18. The program product of claim 17, further comprising:
program code for designating a region to which avatars attempting to access the unavailable region will be teleported;
program code for offering to teleport the avatar to the designated region;
program code for dynamically creating the designated region; and
program code for teleporting the avatar to the designated region.

19. The program product of claim 17, further comprising:
program code for determining whether a similar region is available;
program code for offering to teleport the avatar to a similar region; and
program code for teleporting the avatar to a similar region.

20. A method for deploying an application for redirecting an avatar, comprising:
providing a computer infrastructure being operable to:
identify a region within a virtual universe that an avatar is attempting to access;
determine whether the region is available to the avatar;
determine whether the avatar's attempt to access the region is based on an event scheduled in the region;
determine whether the event has been relocated to a second region;
offer to teleport the avatar to the second region; and
teleport the avatar to the second region.
